(19) United States
(12) Patent Application Publication
(10) Pub. No.: US 2003/0067094 A1
(43) Pub. Date: Apr. 10, 2003

(54) Treating polystyrene foam

(76) Inventors: Richard W. Dempsey, Perryville, MO (US); Thomas A. Redington, Perryville, MO (US); Robert H. Blanpied, Meridian, MS (US); H. Warren Burnam JR., McLean, VA (US)

Correspondence Address: NIXON & VANDERHYE P.C., 8th Floor, 1100 North Glebe Road, Arlington, VA, 22201-4714, US

(21) Appl. No.: 10/247,826

(22) Filed: Sep. 20, 2002

Related U.S. Application Data
(60) Provisional application No. 60/323,317, filed on Sep. 20, 2001.

(51) Int. Cl. B29C 67/20

(52) U.S. Cl. 264/321; 425/445; 264/322; 264/340

(57) ABSTRACT

Method and apparatus are provided for treating (e.g., recycling) polystyrene foam scrap particulate in a manner which increases the density of the polystyrene while minimizing an amount of heat required to convert the polystyrene into densified solid polystyrene plastic (e.g., polystyrene flakes), thereby avoiding noticeable polymer degradation. The invention involves first heating polystyrene particulates to a semi-molten state in a heating zone so that polystyrene particulates coalesce. Pressure is then applied in a pressure zone to the polystyrene while the polystyrene is coalescing. The pressure is applied by a pressure mechanism which crushes the heated and softened polystyrene, and which preferably maintains the pressure on the polystyrene until the polystyrene cools below the softening temperature of the polystyrene. The pressure mechanism squeezes essentially all gases (entrained air and expansion gases) from the polystyrene, and thus precludes, e.g., the rebounding of the polystyrene to a pre-crushed density. The retention of sustained pressure by the pressure mechanism obviates utilization of a degree of heat which would melt the polystyrene to its completely liquid (molten) state. The sustained crushing and cooling of the polystyrene by the pressure mechanism enhances the bulk density of the polystyrene, producing polystyrene chips or flakes having an average thickness in a range of about 0.010 inch to about 0.035 inch. The heater and the pressure mechanism which comprise the apparatus of disclosed techniques and apparatus facilitate treating the polystyrene to obtain an enhanced bulk density throughput index ρ in excess of 500, advantageously enhancing density even when polystyrene of a low input density is utilized.

This application claims the benefit and priority of U.S. Provisional Patent application 60/323,317, filed Sep. 20, 2001, which is incorporated herein by reference in its entirety.

### BACKGROUND

1. Field of the Invention

The present invention pertains to a useful recycled fire-retardant (FR)-treated polystyrene in the form of a high-density plastic product, a method for increasing the density while recycling FR treated polystyrene plastic foam, and apparatus for implementing the method and obtaining the product.

2. Related Art and Other Considerations

The recycling of thermoplastic polymers has been a part of the plastics industry essentially since its inception. Myriad different methods have been developed for reclaiming thermoplastic plastics. Also, many methods have been utilized for recycling thermosetting plastic materials. In the field of plastic foam, both thermosetting and thermoplastic type foams have required conversion to a higher density in a process of being rendered to a reusable form. The most prevalent plastic foam on earth is polystyrene plastic foam.

The common Fire Retardant (FR) materials available for use in polystyrene are usually halogenated materials, ordinarily bromine compounds. When heated in a recycling system, a product containing a bromine compound can become unstable, releasing the bromine atom. This free halogen atom not only tends to quench a fire, but it can also fracture long-chain polymers. When high molecular weight polymers are converted to lower molecular weight polymers by such fracturing, they lose certain desirable properties that had been built into the long-chain polymer. For example, they can become liquid or semi-solid oligomers that are tacky and have no measurable tensile strength. Thus, any successful recycling system for FR treated polystyrene foam should preferably have a heating system that does not degrade the polymer.

The amount of heat energy applied to a plastic over a certain amount of time is called the “heat-history” of a polymer. The “heat-history” can be defined as the aggregate watts (BTU/min) that is represented by the area under a curve created by plotting the time versus the temperature applied to a polymer. The longer a polymer is held at a higher temperature, the higher the heat-history (total watts) and the more degradation will occur. Because bromine mixed with a polymer catalyzes degradation, such a mixture will undesirably degrade at a lower heat-history than a bromine-free polymer.

The prior art is replete with references to techniques for rendering thermoplastic foams more reusable. In recent years, such methods and products thereof have been taught in such United States patents as those bearing the following United States patent numbers (all of which are incorporated herein by reference):

| | | | |
|---|---|---|---|
| 3,389,203 | 3,407,444 | 3,418,694 | 3,504,399 |
| 3,531,562 | 3,607,999 | 3,859,404 | 3,883,624 |
| 4,136,142 | 4,254,068 | 4,504,436 | 5,060,870 |
| 5,118,561 | 5,128,196 | 5,197,678 | 5,217,660 |
| 5,223,543 | 5,266,396 | 5,286,321 | 5,298,214 |
| 5,317,965 | 5,380,767 | 5,406,010 | 5,470,521 |
| 5,494,626 | 5,565,164 | 5,629,352 | 5,645,862 |
| 5,667,746 | 5,882,558 | 6,132,655 | |

Corbett et al. (U.S. Pat. No. 3,607,999) uses vibrating trays in an effort to provide a continuous feed of material. But it has been shown that vibrating trays can not control the forward speed of plastic particles. When the speed is too slow, fires can result. When the speed is too fast, the density of the product is low. Corbett also discloses “a pair of pressure rolls” to “further densify” hot plastic. However, pressure rolls have also been found inadequate because they let a pressed foam quickly rebound, failing to press all the gas from the foam. Corbett further teaches cooling the vibrating table in order to keep a steady flow of material moving. Yet, as the table is cooled from below, it is heated from above. Cooling is also subsequently used by Corbett in that “cooled compression rolls” are required.

Immel et al. (U.S. Pat. No. 3,859,404) utilizes a batch process with an autoclave. In practice, a batch process never achieves the throughput of a continuous mode. While purporting to make a high quality recycled polystyrene, a batch process is slow and expensive. Furthermore, the material must somehow be dried before it is useful.

McKenzie et al (U.S. Pat. No. 3,883,624) relies solely on temperature to remove expansion gas from the foam. McKenzie must melt the polystyrene to 100% liquid in order to release its gases. McKenzie only reduces the thickness to an average of about 1/16-inch.

Louvier (U.S. Pat. No. 4,504,436) discloses a process involving a more gradual increase in heating polystyrene. Louvier utilizes extremely high overhead heat, up to 410° F., which requires rapid transfer through the furnace. The higher pass-through speed allowed some expansion gas to remain in the polystyrene, giving final product densities no higher than 10.9-pcf.

Fuss (U.S. Pat. No. 5,286,321) depends solely upon temperature to expel air and gas. Fuss relies upon hot air to provide the heat necessary to shrink the polystyrene to a densified form without melting it. Without adequate pressure, polystyrene must be melted to insure that all gaseous material is gone. Fuss apparently never intended to achieve a high density.

Thus, over the years there have been many inventions which purport to provide a material from a polystyrene foam recycling system. However, in actual practice, the use of brominated polystyrene foam continued to plague efforts to produce a high quality recycled polystyrene. By the early 1990s, the National Polystyrene Recycling Center had adopted a policy of simply avoiding FR (Fire Retardant) treated polystyrene foam scrap. A decade later, the industry continues to look for a simple, safe, high-speed, essentially labor-free, low-maintenance system for producing material from polystyrene foam scrap.

What is needed, therefore, and an object of the present invention, is apparatus and method which successfully treats or converts polystyrene foam without polymer degradation.

### BRIEF SUMMARY

Method and apparatus are provided for treating (e.g., recycling) polystyrene foam scrap particulate in a manner which increases the density of the polystyrene while minimizing an amount of heat required to convert the polystyrene into densified solid polystyrene plastic (e.g., polystyrene flakes), thereby avoiding noticeable polymer degradation. The invention involves first heating polystyrene particulates to a semi-molten state in a heating zone so that polystyrene particulates coalesce. Pressure is then applied in a pressure zone by a pressure mechanism which crushes the heated and softened polystyrene, and which maintains the pressure on the polystyrene. Preferably the pressure is maintained until the polystyrene cools below the softening temperature of the polystyrene. The pressure mechanism squeezes essentially all gases (entrained air and expansion gases) from the polystyrene, and thus precludes, e.g., the rebounding of the polystyrene to a pre-crushed density. Preferably the pressure mechanism serves to essentially eliminate the cellular structure (cells) which typically exists in the (predominately cellular) input polystyrene. The retention of sustained pressure by the pressure mechanism obviates utilization of a degree of heat which would melt the polystyrene to its completely liquid (molten) state.

The sustained crushing of the polystyrene by the pressure mechanism enhances the bulk density of the polystyrene, producing polystyrene chips or flakes having an average thickness in a range of about 0.010 inch to about 0.035 inch. Moreover, the resultant polystyrene flakes are fairly clear and, upon exiting the pressure zone, are below a predetermined temperature.

The heater and the pressure mechanism which comprise the apparatus of the present invention facilitate treating the polystyrene to obtain an enhanced bulk density throughput index ρ in excess of 500 (i.e., ρ>500), and preferably in excess of 600 (i.e., ρ>600). The enhanced bulk density throughput index ρ is defined by the expression ρ=ΔBD×S×(1 min/ft), wherein ΔBD is a ratio of the bulk density of output polystyrene flakes to the bulk density of input polystyrene material; and S is a measure of the running speed of the polystyrene through the process (e.g., conveyance speed) in feet per minute. In an example which processes 0.75 pounds/cubic foot into 27+ pounds/cubic foot at a rate of about 204 pounds per hour, the enhanced bulk density throughput index ρ is about 1080. As compared to a process which begins with polystyrene having a bulk density of about 1.5 pounds/cubic foot, the apparatus and process of the present invention can work with polystyrene of about half the bulk density of input polystyrene. Despite having less mass with which to work, the apparatus and process of the present invention produces resultant polystyrene having a bulk density in a desirable range (27 pounds/cubic foot to 30 pounds/cubic foot or more).

In one example implementation, the polystyrene is conveyed to the heating zone having the heater which heats the polystyrene, and from the heating zone to the pressure zone where the pressure is applied by the pressure mechanism. Conveyance is provided by a first conveyor belt or feeder belt which conveys the polystyrene foam to the heater and from the heater to the pressure mechanism. In an illustrated example embodiment, the pressure mechanism comprises a second belt situated in opposing relationship to the first conveyor belt. The first and second belts apply a continuous force to the polystyrene foam conveyed between the first conveyor belt and the second belt. A first surface of each belt contacts the polystyrene, while in an example, non-limiting implementation, a second surface of each belt contacts respective heat sinks.

The belts utilized to convey the polystyrene through the heating zone and which form the pressure zone are preferably thin stainless steel belts which serve as good conductors of heat. A major advantage of a pressure zone made of opposing double belts as compared to a pressure zone made of one belt opposed to several rollers is that the plastic can be substantially reduced in thickness. The thinner the plastic, the faster the heat will be removed. The heat sinks are situated proximate the belts in the pressure zone to facilitate cooling of the belts and thus cooling also of the polystyrene. In one embodiment, the heat sinks comprise heat-conductive rollers which also assist in maintaining pressure application to the cooling polystyrene. In another embodiment, the heat sinks comprise finned aluminum plate material. A cooling system is also optionally provided for cooling of the heat sinks. In an example implementation, the cooling system is a moving air cooling system.

The scrap foam may not always be evenly distributed or deposited across the width of the feeder belt. Because of this uneven loading of scrap foam across the width of the feeder belt, more pressure will occur where more foam is being crushed by belt action. When uneven force occurs on the left side of a belt, this will cause the belt to wander toward the right side, and vice versa. Thus, in an illustrated example embodiment, a steering mechanism is provided to urge the wandering belt back into correct alignment, e.g., toward a predetermined alignment (e.g., alignment with end rollers about which the thin conveyor belts are entrained). The steering system comprises a sensor (e.g., optical sensor) and an actuator which changes an axial inclination of a steering roller upon detection of misalignment, so that a major axis of the steering roller tilts (relative to an axis of conveyance of the polystyrene) to cause the steering roller to contact a conveyor exterior surface and thereby urge the stainless steel conveyor into alignment, e.g., with its end rollers.

In one illustrated embodiment, the pressure zone and the heating zone are horizontally aligned so that the polystyrene travels a planar horizontal path through both zones. In another embodiment, the pressure zone planar but situated beneath the heating zone, with the direction of polystyrene travel is reversed between the heating zone and the pressure zone.

As another aspect of the invention, the heater comprises plural heat emitter panels mounted on a single frame that is selectively movable (e.g., pivotable) between proximate or non-proximate positions relative to the polystyrene foam. A variable voltage supply heats the plural heat emitter panels to an infrared wavelength suitable for the polystyrene foam.

### BRIEF DESCRIPTION OF THE DRAWINGS

The foregoing and other objects, features, and advantages of the invention will be apparent from the following more particular description of preferred embodiments as illustrated in the accompanying drawing in which reference characters refer to the same parts throughout the various views. The drawing is not necessarily to scale, emphasis instead being placed upon illustrating the principles of the invention.

FIG. 1 is a schematic front side view of an example system, according to a first embodiment of the invention, for treating polystyrene foam.

FIG. 2 is a perspective front side view showing portions of the example embodiment of FIG. 1.

FIG. 3 is a schematic rear side view of portions of the example embodiment of FIG. 1, showing in particular a roller tray and portions of a cooling system interfacing with a first conveyor.

FIG. 4 is a perspective front side view of portions of a cooling system of the example embodiment of FIG. 1.

FIG. 5 is a perspective rear end view showing discharge of polystyrene flakes from a pressure zone of the example embodiment of FIG. 1.

FIG. 6 is a side perspective view showing a steering system utilized in conjunction with the example embodiment of FIG. 1.

FIG. 7 is an end perspective view of portions of the steering system of FIG. 6.

FIG. 8 is a schematic side view of an example system, according to a second embodiment of the invention, for treating polystyrene foam.

FIG. 9 is an enlarged schematic side view of a conveyor portion of the example embodiment of FIG. 8.

FIG. 10 is a further enlarged schematic side view of an alternative conveyor portion of the example embodiment of FIG. 1 and/or FIG. 8.

FIG. 11 is a top perspective view of an example cooling plate utilized in the alternative example embodiments of the invention.

### DETAILED DESCRIPTION OF THE DRAWINGS

In the following description, for purposes of explanation and not limitation, specific details are set forth such as particular techniques, etc., in order to provide a thorough understanding of the present invention. However, it will be apparent to those skilled in the art that the present invention may be practiced in other embodiments that depart from these specific details. In other instances, detailed descriptions of well-known devices and methods are omitted so as not to obscure the description of the present invention with unnecessary detail.

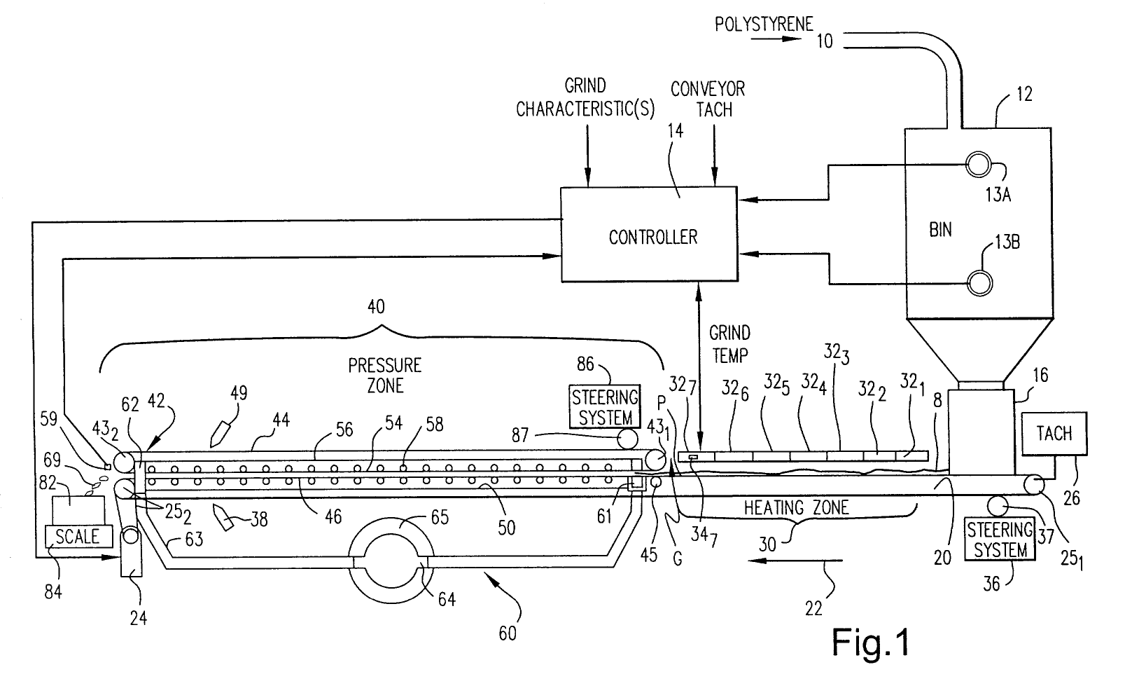

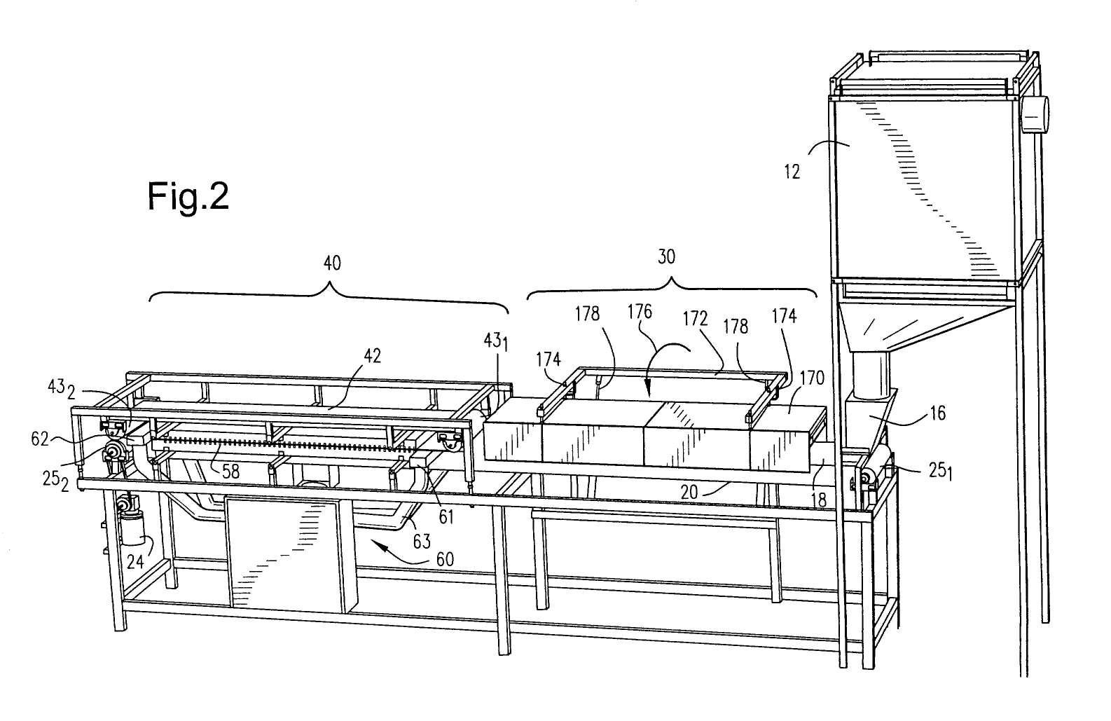

FIG. 1 and FIG. 2 illustrate a first example embodiment of structure and operation of the invention. FIG. 1 illustrates the first embodiment with a general schematic representation; FIG. 2 provides a perspective view of selected aspects of the first embodiment. Coarsely ground foamed polystyrene granules (a.k.a. “grind”) are air-conveyed through duct 10 into bin 12. Bin 12 is automatically kept filled using level detectors (such as detectors 13A and 13B). The first embodiment optionally includes a controller 14 which (among other things) can selectively turn on an illustrated air-conveyer system which applies the granules to duct 10, and thus to bin 12. A feed chute 16 at a discharge of bin 12 lays a blanket of grind onto a top or outer surface 18 of conveyor belt 20. The conveyed grind is also referred to herein as polystyrene particulates and polystyrene granules. An unillustrated slide gate controls discharge of the grind onto surface 18 of conveyor belt 20, and thus the thickness of the grind layer on belt surface 18.

Conveyor belt 20 is preferably a stainless steel belt, and more preferably a thin stainless steel belt. One example stainless steel belt useful for the present invention has a thickness of 12 mils (e.g., 12/1000 inch). In the example illustrated embodiment, the end rollers 25 about which belt 20 is entrained have a diameter of approximately six inches. Conveyor belt 20 is actuated so that the grind deposited thereon travels in a direction depicted by arrow 22 (the transport or conveyance direction).

Actuation of conveyor belt 20 can be by any of various means, including rollers or gears driven by motors. In the illustrated embodiment, a suitable transmission system applies rotational motion from motor 24 to drive roller 25₂ (also known as end roller 25₂). The conveyor belt 20 is entrained about end roller 25₁ (near the beginning of the course of travel of the conveyed grind deposited on belt 20) and drive roller 25₂ (at the end of the course of travel). In order for the conveyed grind to be transported in the direction of arrow 22, end rollers 25 rotate counterclockwise as seen in FIG. 1. In the illustrated embodiment, the speed of motor 24, and thus the speed of travel of grind on surface 18 of conveyor belt 20, is governed by controller 14. The actual speed of conveyor belt 20 can be detected by a tachometer 26 or the like, and (if desired) supplied to controller 14.

As shown in FIG. 1, a steering system 36 is provided for first conveyor belt 20 to, e.g., keep first conveyor belt 20 in alignment(e.g., properly positioned relative to the end rollers 25 about which conveyor belt 20 is entrained). As described in further detail subsequently, the steering system 36 includes a steering roller 37.

At one or more positions, a lubricant is preferably applied to the outer surface 18 of first conveyor belt 20. For the illustrated example embodiment, the lubricant is applied by lubricant spray nozzles 38 (see FIG. 1). The lubricant can be, for example, a commercially available oil such as cooking oil (e.g. Wesson® oil, for example).

The belt 20 conveys the polystyrene foam grind into a heating zone 30. Heating zone 30 preferably comprises plural infrared (IR) heat emitter panels 32, which individually and/or collectively form a heater. For sake of illustration, seven such heat emitter panels 32₁-32₇ are shown as comprising the heater in the heating zone 30. It should be understood that a greater or lesser number of heat emitter panels 32 can be employed. In an illustrated embodiment and example mode of operation, in heating zone 30 the polystyrene reaches a temperature in an example range of between 220 degrees F. and 230 degrees F. A temperature sensor, such as temperature sensor 34₇ shown proximate heat emitter panel 32₇, can apprise controller 14 of the temperature of the polystyrene foam grind at one or more positions along the heating zone 30.

The infrared energy applied in the heating zone 30 primarily affects the polystyrene traveling on first conveyor belt 20. Due to the heating in the infrared emitter area (e.g., heating zone 30), the polystyrene foam grind (“the material”) begins to coalesce; e.g., the discrete particles convert to a semi-molten state and join to form large globules, nearly forming a continuous mass. The polystyrene foam grind is converted to a semi-molten state, but not a pure molten state (e.g., not to a pure fluid), since the temperature required to convert polystyrene to a molten state is about 300 degrees F. Thus, the semi-molten state polystyrene globules are sticky, but not fluid. Advantageously, the semi-molten state polystyrene globules do not stick significantly to first conveyor belt 20 in view of the stainless steel composition of first conveyor belt 20 and the fact that first conveyor belt 20 is sprayed (e.g., by spray nozzles 38) with the lubricant. Moreover, in view of its small thickness and stainless steel composition, exposure per se of bare portions of the first conveyor belt 20 to the infrared energy incident thereon in heating zone 30 contributes but little heating to the first conveyor belt 20, as bare portions of the first conveyor belt 20 appear essentially to reflect incident radiation.

Upon exiting from heating zone 30, the polystyrene material enters a pressure zone 40. In pressure zone 40 the preferably coalescing material, being transported on moving conveyor belt 20, is crushed in a pressure mechanism.

In the first illustrated embodiment, the pressure mechanism takes the form, at least in part, of a further or second conveyor belt 42. The second conveyor belt 42 is made of the same type of thin stainless steel as the first belt 20. The second conveyor belt 42 is positioned directly above a downstream segment of the first conveyor belt 20. The second conveyor belt 42 is entrained about upstream end roller 43₁ and downstream end roller 43₂. The downstream roller 43₂ for second conveyor belt 42 is vertically aligned with roller 25₂ for first conveyor belt 20. The downstream roller 43₂ for second conveyor belt 42 is geared to be driven by motor 24 along with roller 25₂, but with roller 43₂ being driven to rotate in opposite direction from roller 25₂. That is, roller 43₂ rotates clockwise as seen in FIG. 1. Vertically aligned beneath the upstream roller 43₁, for second conveyor belt 42 is a crush roller 45 (see FIG. 1) which contacts a second or inner surface 46 of the first belt 20 along the upper path of travel of first belt 20. In the illustrated embodiment, the crush roller 45 has a diameter of two inches.

In the illustrated embodiment, in their course of proximate travel facing each other, there is a gap of about 0.020 inch between the outer surface 18 of first conveyor belt 20 and an outer surface 44 of second conveyor belt 42.

Thus, in the first embodiment the pressure mechanism comprises second belt 42 situated in opposing relationship to first conveyor belt 20, and above first conveyor belt 20. A continuous compressive force is applied to the polystyrene P conveyed between first conveyor belt 20 and second belt 42. In particular, the outer surface 18 of belt 20 and the outer surface 44 of belt 42 contact and crush the polystyrene traveling therebetween. In particular, the pressure mechanism provided by first conveyor belt 20 and second conveyor belt 42 applies pressure to crush the heated and softened polystyrene and maintains the pressure on the polystyrene. Preferably the pressure is maintained until the polystyrene cools below the softening temperature of the polystyrene.

A lubricant spray nozzle 49, similar to nozzle 38 already described, is positioned to spray a lubricant on outer surface 44 of second conveyor belt 42. In the illustrated embodiment, lubricant spray nozzle 49 sprays the lubricant on the outer surface 44 along the upper course of travel of second conveyor belt 42.

The thin, stainless steel belt which comprises each of first conveyor belt 20 and second conveyor belt 42 is a good heat conductor. Heat acquired by the belts 20 and 42 by virtue of the heated polystyrene being in contact therewith tends to be conducted through the belts 20, 42. In order to assist with dissipation of this conducted heat, pressure zone 40 also includes a heat sink for each of first conveyor belt 20 and second conveyor belt 42. In particular, the second or inner surface 46 of the first belt 20 contacts a first heat sink assembly 50, while a second or inner surface 54 of second conveyor belt 42 contacts a second heat sink assembly 56.

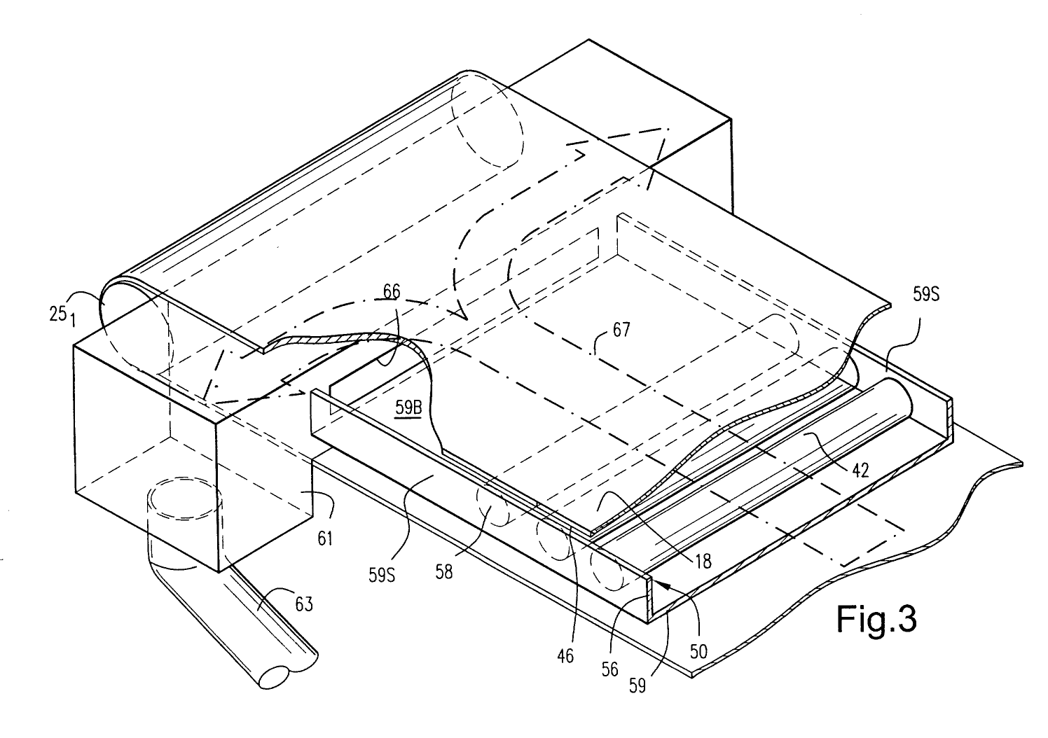

Each heat sink assembly 50, 56 includes a series of aluminum rollers 58. The aluminum rollers 58 are housed in roller trays 59. As shown in FIG. 3, the roller trays 59 have a bottom wall 59B and two opposing side walls 59S. The sidewalls 59S extend essentially in the direction of conveyance (the direction of arrow 22), with the rollers 58 extending in parallel to one another between opposing sidewalls 59S (e.g., the rollers 58 have major axes which are orthogonal to opposing sidewalls 59S). The roller trays 59 have open ends in the direction orthogonal to opposing sidewalls 59S (e.g., the roller trays essentially have no ends, or at least fluid permeable/transmissible ends).

The aluminum rollers 58 are situated in roller trays 59 to bear against the second or inner surface of a conveyor belt. That is, the aluminum rollers 58 of first heat sink assembly 50 have upper tangential surfaces which bear against second or inner surface 46 of the first belt 20; the aluminum rollers 58 of second heat sink assembly 56 have lower tangential surfaces which bear against second or inner surface 54 of the second belt 42. In the illustrated example embodiment, the aluminum rollers 58 have a diameter of approximately one inch, with centers of the aluminum rollers 58 being located about 1.25 inches apart.

The aluminum composition of rollers 58 of the heat sink assemblies 50, 56 thus serve to dissipate heat conducted through the respective conveyor belts 20, 42. Moreover, in addition to the heat dissipation (e.g., cooling) provided by aluminum rollers 58, both conveyor belts 20, 42 are also supported by the aluminum rollers 58, thereby enabling belts 20, 42 to apply sustained moderate compression forces on the polystyrene P traveling therebetween in pressure zone 40.

The crushing force exerted by belts 20, 42 (reinforced by heat sink assemblies 50, 56) forces essentially all the air and residual gases out of the polystyrene. Preferably the crushing force exerted by belts 20, 42 aids or serves to essentially eliminate the cellular structure (cells) which typically exists in the (predominately cellular) input polystyrene. Moreover, in the illustrated embodiment in which the pressure mechanism also cools the polystyrene, the force exerted by the belts 20, 42 holds the polystyrene polymers under pressure as the polymer cools. Concurrent with the crushing between the conveyor belts 20, 42, the polystyrene material P is cooled by the conduction of heat through the first conveyor belt 20 and second conveyor belt 42 (from which heat is dissipated by the respective heat sink assemblies 50, 56).

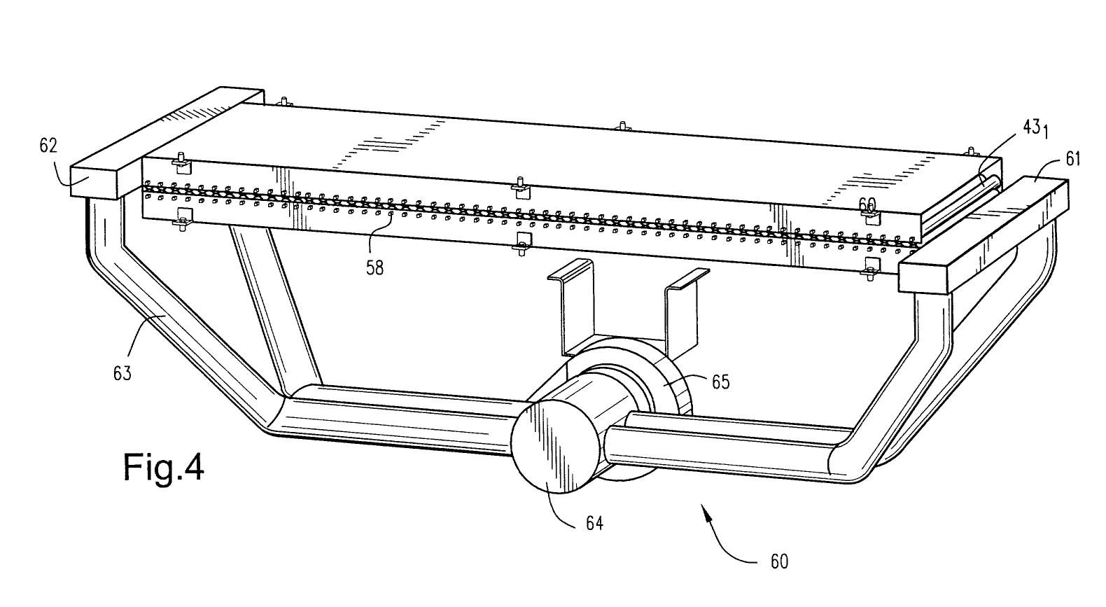

In the illustrated example embodiment, a cooling system 60 is provided for cooling the heat sink assemblies 50, 56. As shown in FIG. 1 and FIG. 4, the cooling system 60 includes lower heat sink cooling manifold 61; upper heat sink cooling manifold 62; cooling hoses 63; hose interface manifold 64; and blower 65. FIG. 3 shows a rear portion of first conveyor belt 20 near its entry end roller 25₁. FIG. 3 and FIG. 4 illustrate various aspects of the cooling system 60. In particular, FIG. 3 shows lower heat sink cooling manifold 61 extending parallel to and downstream from entry end roller 25₁, and interposed between the top path of travel and bottom path of travel of first conveyor belt 20. The lower heat sink cooling manifold 61 has an opening 66 which faces the open end of roller tray 59. At each of its ends, apertures formed in the bottom of lower heat sink cooling manifold 61 connect to first ends of cooling hoses 63. A second end of each cooling hose 63 is connected to hose interface manifold 64 (see FIG. 1). The hose interface manifold 64 communicates with blower 65.

The blower 65 is operated to draw air or other fluid through cooling system 60. In particular, in the example illustrated embodiment, the blower 65 is operated to draw or impel air or other fluid across the aluminum rollers 58 (thereby dissipating heat in the aluminum rollers 58), through the open end of roller tray 59 and (via opening 66) into the appropriate one of the heat sink cooling manifolds (in the direction of arrow 67 in FIG. 3), through the two hoses 63 which communicate with the heat sink cooling manifold, through hose interface manifold 64, and through blower 65. The end of roller tray 59 which opposes the end which abuts opening 66 is completely open (there being no manifold structure at that opposing end), so that air can be impelled into roller tray 59 and pass through roller tray 59 (thereby cooling the aluminum rollers 58) in the manner just described.

In the illustrated, example, non-limiting embodiment and mode of operation, the polystyrene is cooled in the pressure zone 40 to a predetermined temperature which is below its “softening point”. Various types of polystyrene foam have different “softening points”. Simply put, the “softening point” is that temperature whereby a material can be reshaped and will hold the new shape. Sometimes this softening point is also referred to as a glass transition point. More precisely, the softening point is that temperature where the plastic starts transitioning from a solid to a pliable form that can be reshaped. Most often this softening point temperature for polystyrene is in a range of from about 166 degrees F. to about 230 degrees F., depending upon the grade of the polystyrene, and is commonly in a range of from about 170 degrees F. to about 200 degrees F. for most grades. In the non-limiting examples herein described, the speed of the bottom belt 20 is set such that the final product being produced is a fairly clear solid at a temperature below the softening point (so that, e.g., there is no sticking of the final product), and typically below 150° F. and preferably below 100° F. depending on ambient conditions and the throughput speed. When the temperature of this solid is below 150° F., and preferably below 100° F. and on the order of about 90° F., it has better ease and safety in handling. The temperature of the polystyrene foam grind upon leaving the pressure zone 40 is detected by optional temperature sensor 59, which (optionally) reports the exit temperature to controller 14 (see FIG. 1).

In addition to the benefits elsewhere mentioned, the heat sink assemblies 50, 56 and the cooling system 60 as well as the belt lubrication effectively counteract a tendency for the hot, melted polystyrene sandwiched between conveyor belts 20 and 42 in pressure zone 40 to glue or adhere the belts together.

In alternate unillustrated embodiments the pressure mechanism does not perform substantial cooling, but rather is aided or augmented so that cooling is performed in a cooling zone which is situated downstream from the pressure zone. Cooling can be accomplished in the cooling zone by various techniques, such as by cooling fluids, for example.

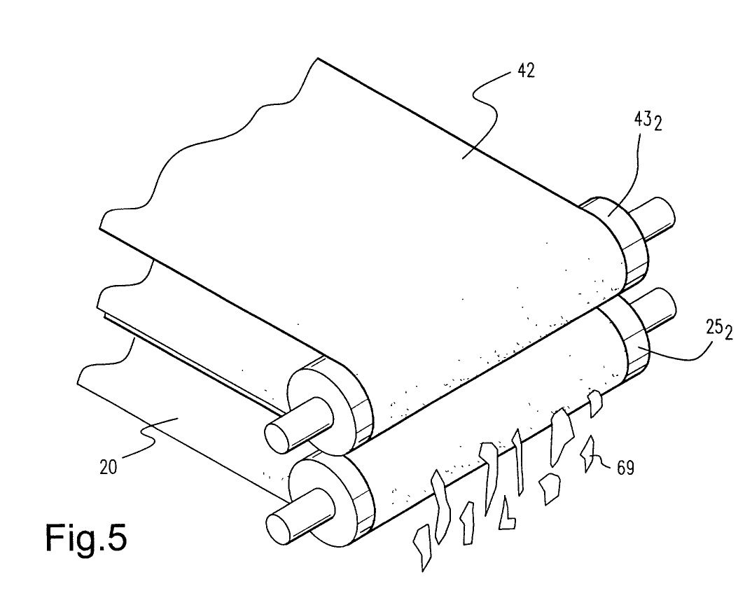

FIG. 5 shows a series of resulting polystyrene flakes or chips 69 which are exiting from between first conveyor belt 20 and second conveyor belt 42 (e.g., at the left end of the conveyors in FIG. 1). Although only a few such flakes 69 are shown in FIG. 5, it will be understood that under normal circumstances the discharge of flakes 69 is essentially continuous. The flakes 69 preferably have a thickness of from about 0.010-inch thick to about 0.035-inch, and preferably have a “Bulk Density” in excess of 27 pounds per cubic foot. When the temperatures are properly set, the flakes 69 are fairly clear. The terms “relatively clear” and “fairly clear” mean that flakes 69 are generally clear but may have some opaque area, yet with little and preferably no yellowness.

The material (e.g., polystyrene flakes 69) drop or fall from belt 20 as belt 20 bends over the radius of its exit roller 25₂. The polystyrene flakes 69, having been cooled (e.g., in pressure zone 40 or an alternate cooling zone) to a temperature below 150 degrees F., and preferably below 100 degrees F., have lost their stickiness, and are now brittle and chip-like. The exiting flakes 69 fall into a holding bin collection box 82 (see FIG. 1) until the box 82 and its contents attain a suitable weight. Collection box 82 can be, for example, a four-foot high by four-foot square (width) box (a.k.a. Gaylord®), which can be filled until a scale 84 registers a suitable weight (e.g. between 700 and 800 pounds).

A steering system 86 is provided for second conveyor belt 42 to, e.g., keep second conveyor belt 42 in alignment to the end rollers (e.g., end rollers 43) about which conveyor belt 42 is entrained. As described in further detail subsequently, the steering system 86 includes a steering roller 87.

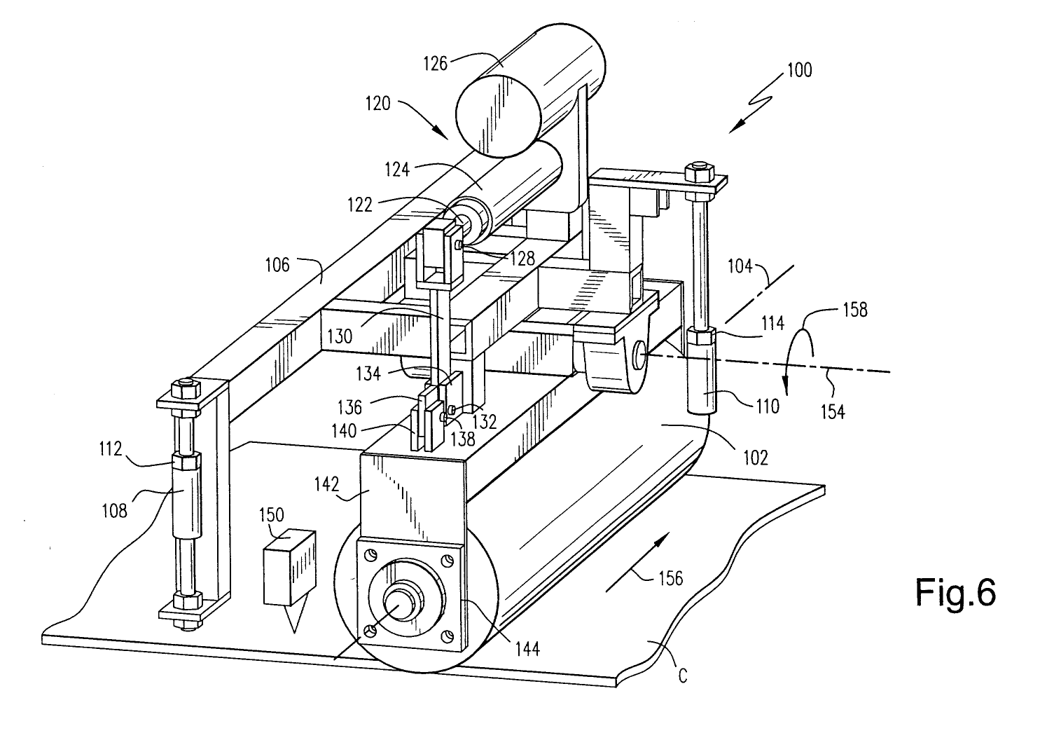

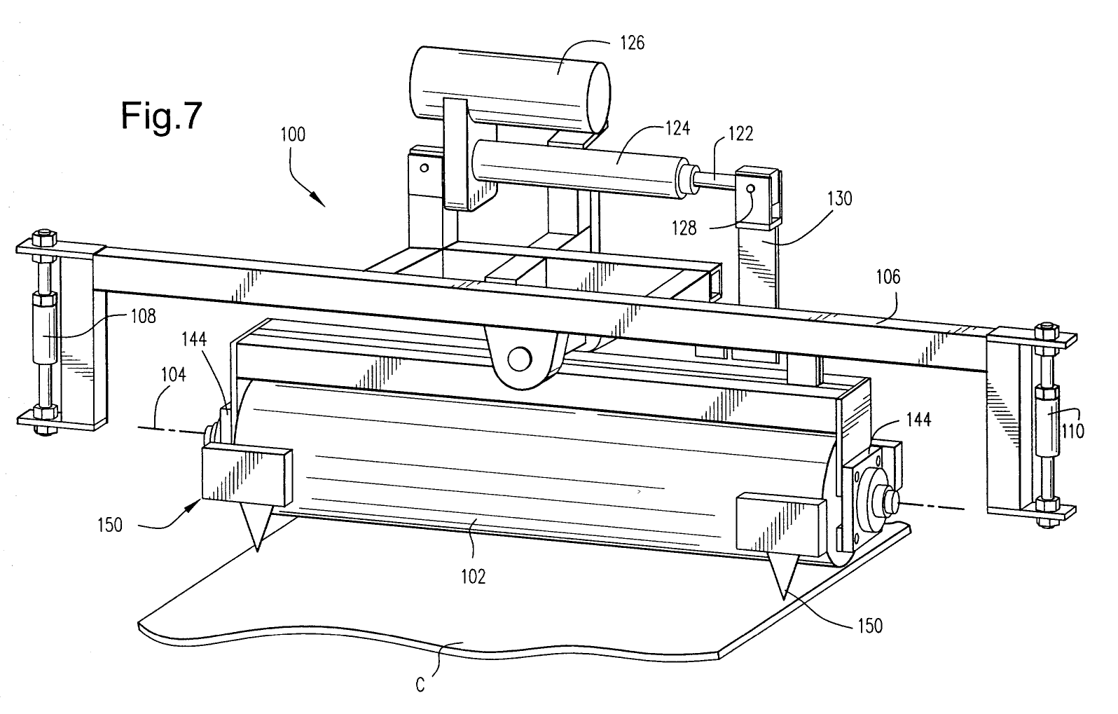

The steering system 36 for first conveyor belt 20 and the steering system 86 for second conveyor belt 42 are essentially identical in structure and function, and as such both steering system 36 and steering system 86 are depicted by the generic steering system 100 illustrated in FIG. 6 and FIG. 7. The generic steering system 100 (which could correspond to either steering system 36 for first conveyor belt 20 or the steering system 86 for second conveyor belt 42) comprises steering roller 102 (which could correspond either to steering roller 37 of steering system 36 or steering roller 87 of steering system 86). The steering roller 102 has a steering roller axis 104.

The steering system 100 further comprises a steering system frame 106. The steering system frame 106 is mounted to a frame of the overall apparatus so that a tangential surface of steering roller 102 contacts a first side of one of the conveyor belts. For example, when the steering system 100 is the steering system 86 for second conveyor belt 42, a bottom tangential surface of steering roller 102 (corresponding to roller 87) contacts the first or outer surface 44 of second belt 42, essentially with the orientation shown in FIG. 6 and FIG. 7. On the other hand, when the steering system 100 is the steering system 36 for first conveyor belt 20, a top tangential surface of steering roller 102 (corresponding to roller 37) contacts the first or outer surface 18 of second belt 20, with an orientation essentially opposite to that shown in FIG. 6 and FIG. 7. The height of steering system frame 106 relative to the conveyor belt is adjustable by provision of height adjustment springs 108 and 110. In particular, nuts 112 and 114 can be adjusted to change the position of height adjustment springs 108 and 110, respectively. By controlling the height adjustment springs 108 and 110, the degree of contacting pressure applied by steering roller 102 to the conveyor it contacts can be adjusted.

The steering system 100 as seen in FIG. 6 further comprises an actuator 120 which changes an axial inclination (e.g., the inclination of axis 104) of the steering roller 102. The actuator 120 has a piston-like linear actuator 122 which selectively extends or withdraws from an actuator cylinder 124 in accordance with actuator motor 126. The linear actuator 122 has a distal end which is connected at pivot point 128 to an L-shaped linkage member 130. The L-shaped linkage member 130 has a heel portion which is pivotally connected at pivot point 132 to frame block 134, and a toe portion 136 which is pivotally connected at pivot point 138 to extension blocks 140 of a steering roller bracket 142. The steering roller bracket 142 has distal flanges 144 between which ends of the steering roller 102 are rotatably retained along axis 104.

The steering system 100 also comprises a pair of conveyor detectors, such as conveyor edge detectors which can be in the form of reflective photodetectors or the like, illustrated as photodetectors 150 in FIG. 6 and FIG. 7. The photodetectors 150 are situated so that the beams thereof are in alignment with desired positions of the edge of the particularly conveyor C which is being monitored and steered by steering system 100. In FIG. 7, conveyor C represents first conveyor 20 when the steering system 100 is the first steering system 36, but conveyor C represents second conveyor 42 when the steering system 100 is the second steering system 86.

The steering system 100 serves to retain the stainless steel conveyor C in alignment relative to the end rollers about which the conveyor C is entrained, so that the conveyor C does not “walk off” or deviate from entrainment about the end rollers. The exceedingly thin nature of the stainless steel conveyor C renders conveyor C very susceptible to such deviation, particularly if the polystyrene loading on the feed conveyor is unbalanced or uneven.

In operation, the photodetectors 150 detect misalignment of the stainless steel conveyor C. Such detection occurs when one of the photodetectors 150 of a pair sees or detects the conveyor C, but the other or second one of the photodetectors 150 of a pair does not detect the conveyor C. Upon detection of misalignment by the photodetectors 150, the steering roller 102 is activated by actuator 120 in such a way that steering roller 102 contacts an exterior surface of the stainless steel conveyor C to urge the stainless steel conveyor C into alignment with the end rollers about which the conveyor C is entrained.

In view of the pivoting capability of L-shaped linkage member 130 as operated under the influence of actuator 120, the actuator 120 is pivotally mounted to steering system frame 106. That is, the axis 104 of steering roller 102 is selectively pivotable about axis 154. Axis 154 is essentially parallel to the path or direction of travel of the conveyor C, with the result that the axis 104 of steering roller 102 is selectively pivotable about the path or direction of travel of the conveyor C.

As an example of such steerage of conveyor C, suppose that the photodetector 150 illustrated in FIG. 6 does detect conveyor C, but the other (unillustrated in FIG. 6) photocell of the pair does not detect conveyor C. In such case, conveyor C needs to be urged in the direction depicted by arrow 156 in FIG. 6. Accordingly, upon the sensing of the imbalance in signals between the illustrated and unillustrated photodetectors 150, actuator 120 will be actuated to extend linear actuator 122, and thereby cause the axis 104 of steering roller 102 to pivot about the axis 154 in the counterclockwise direction illustrated by arrow 158 in FIG. 6. Such pivoting will cause the end of steering roller 102 nearest the viewer in FIG. 6 to apply greater contact pressure to conveyor C, thereby urging conveyor C in the direction of arrow 156 until a balance is restore in the signals obtained from the pair of photodetectors 150 (e.g., so that both photodetectors 150 of the pair can detect the conveyor, meaning that the conveyor is properly aligned with its end rollers and therefore properly centered on its direction of travel). Essentially reverse operations are performed in the situation in which the photodetector 150 illustrated in FIG. 6 does not detect conveyor C, but the other (unillustrated in FIG. 6) photocell of the pair does detect conveyor C.

The panels 32 of heating zone 30 are heated by a variable voltage supply able to tune in the best infrared wavelength for the grind. The variable voltage supply can be manually set (e.g., using a SCR voltage regulator), or controlled by controller 14, or a combination of both. As shown in FIG. 2, the heating panels 32 can be mounted in (e.g., suspended from) a heating zone hood 170. The heating zone hood 170 is held aloft above first conveyor 20 by a hood carriage 172. The hood carriage 172 is capable of pivoting motion about pivot points 174. The heating zone hood 170, and thus the heating panels 32, can be retracted from proximate the first conveyor belt 20 in the path of arrow 176 (see FIG. 2) by moving hood carriage 172 about its pivot points 174. Such movement of hood carriage 172 can be effected by actuators 178.

The optional controller 14 can be used to control automatically the speed of the conveyors 20 and 42. The desired time period for the polystyrene to be in pressure zone 40 depends on such factors as heating temperature and the physical properties of the polystyrene. FIG. 1 shows that controller 14 can be supplied with polystyrene (e.g., grind) characteristic information. Controller 14 can adjust, among other things, the temperature applied in heating zone 30 and the travel speed of conveyor 20 so that the desired coalescence temperature is obtained. As necessary, the controller 14 control actuators 178 in order to engage or disengage the heat emitting panels 32 with the polystyrene foam grind passing therebeneath.

In embodiments in which it is utilized, the functions of controller 14 may be implemented using individual hardware circuits, using software functioning in conjunction with a suitably programmed digital microprocessor or general purpose computer, using an application specific integrated circuit (ASIC), and/or using one or more digital signal processors (DSPs).

The present invention markedly differs from the prior art which has relied essentially solely upon heat to rid the foam scrap of its entrained gases. The present invention makes use of a crushing mechanism (e.g., belt 42) that sustains pressure on polystyrene foam while it is off-gassing. Preferably the crushing mechanism holds the pressure on it until the polystyrene cools below its softening point. A major advantage of a pressure zone made of opposing double belts as compared to a pressure zone made of one belt opposed to several rollers is that the plastic can be substantially reduced in thickness. A series of rollers (only) as one opposing-half of the pressure zone is not capable of making plastic as thin as about 0.010 inch to about 0.035 inch. Individual rollers set to 0.010-inch clearance fail to stop the softened plastic from rebounding. The thinner the plastic, the faster the heat will be removed.

The length of the pressure zone 40 and cooling efficiency will determine how fast the apparatus can run, assuming enough heat emitters are provided. Since infrared heat emitters are economical, adding more and longer sections of these is easily done. Longer runs of heating sections invites substantial speed increases, but only if the cooling and crushing sections are also lengthened. If the cooling and crushing sections are lengthened such that the lengthened heater section can run on “high” and the plastic is still cooled below its softening temperature, a new, higher, maximum throughput will be obtained. The apparatus can be widened to increase the output. Likewise, side-guides could hold deeper thicknesses of low density foam on the bottom conveyor belt, and with the top conveyor system 40 being flexible upward, higher throughput is possible. Thus the apparatus can be enlarged in any of its three dimensions and that enlargement translates into higher output.

The process of the present invention reduces the thickness of recycled polystyrene (e.g., resulting polystyrene chips) to an average range of about 0.010-inch to about 0.035-inch. This thickness is believed to be far lower than that resulting from any prior art practice. The thickness of the final material is desirable as it relates to high quality. A high quality recycled polystyrene material is thus provided by the present invention. The resultant material has been processed with the least amount of total heating energy possible. This higher quality is the result of a method that minimizes the amount of heat required to convert polystyrene foam scrap back into solid polystyrene plastic without noticeable polymer degradation. Entrained air and expansion gases can be squeezed out of polystyrene foam scrap at the coalescing temperature. To achieve this, a continuous crushing zone (e.g., pressure zone 40) is provided wherein essentially all gases are eliminated without the need to add enough additional heat to melt the polystyrene to its completely liquid state.

By removing all gases quickly at the lowest possible heat-history, in the present invention the cooling process begins sooner and the desired lower temperature reached in less time. Because the present invention crushes polystyrene to a thin layer, it can cool the polystyrene very quickly. The opposing crushing belts 20, 42 are made from thin material that utilize a superior cooling method. The crushing belts 20, 42 work in conjunction with heat-sinks 50, 56 situated on their backside, which are easily cooled by moving ambient air provided by cooling system 60. This system costs less than using cooled water sprays and cold air from air conditioners.

As one of the many aspects of the present invention, very low bulk density input polystyrene can be converted into undamaged high bulk density plastic, and at a very high throughput. By “undamaged” is meant that there is no fracturing or comparable degradation of the polymers.

The example apparatus of FIG. 1 and the technique of the present invention are able to process scrap polystyrene foam having a density as low as 0.5 pounds per cubic foot (“PCF”), and commonly averaging around 0.75 PCF, into 27+ PCF plastic at a running speed of about 30 feet per minute (fpm), e.g., with the conveyor belts traveling at about 30 feet per minute in their direction of conveyance. With a narrow (11-inches) width perpendicular to the direction of conveyance, and a deposit of scrap foam about 2 inches high on the feed conveyor belt, this example apparatus sustained a production rate of about 272 cubic feet per hour, or about 204 pounds per hour. Wider foam paths and higher speed rates can easily be obtained in view of the continuous crushing and cooling aspects of the apparatus. A major advantage of the present invention is that it is usable with initial polystyrene bulk densities in a range which includes, e.g., 0.50 pounds/cubic foot and greater.

The pressure mechanism in pressure zone 40 provides controlled cooling and pressure. The controlled cooling and pressure is sufficient so that polystyrene exiting the pressure mechanism with a density of about 28 pounds per cubic foot or greater is obtained from polystyrene foam having a density prior to heating as low as about 0.50 pounds per cubic foot.

The throughput of many technologies can be increased, to some extent, by simply increasing the scale of production (e.g., by increasing one or more physical dimensions). For a conveyor-utilizing foam technology, throughput can be increased somewhat by various dimensional techniques, such as simply by widening or enlarging the capacity of the conveyor, or increasing the transport speed. However, such scale increases result in throughput increases only up to a certain point in conventional conveyor-utilizing foam reclamation apparatus which are throughput-limited by structure or operation. For example, conventional conveyor-utilizing foam reclamation (lacking the continuous crushing and cooling of the polystyrene according to the present invention) are unable to operate at higher conveyance speeds in view of limitations on the cooling process, and accordingly cannot sufficiently process the low density of the most prevalent scrap foams which are common today (having a bulk density lower than 1.5 PCF, and typically below 1.0 PCF such as 0.5 PCF to 0.75 PCF).

Mathematically, certain advantages of the conversion method facilitated by the present invention can be expressed in terms of an enhanced bulk density throughput index ρ which is defined by Expression 1.

ρ=ΔBD×S×(1 min/ft) Expression 1

In Expression 1, ρ is the enhanced bulk density throughput index, ΔBD is a ratio of the bulk density of the output polystyrene flakes (e.g., in pounds/cubic foot) to the bulk density of the input polystyrene material; and S is a measure of the running speed of the polystyrene through the process (e.g., conveyance speed) in feet per minute. The present invention can be utilized to obtain an enhanced bulk density throughput index ρ in excess of 500 (i.e., ρ>500), and preferably in excess of 600 (i.e., ρ>600).

An example which processes polystyrene having an input density of 1.50 pounds/cubic foot into output polystyrene having a bulk density of 27 pounds/cubic foot or greater and running at a rate of 30 feet per minute or greater yields a ρ value of about 540 or greater.

Another example which processes polystyrene having an input density of 1.0 pounds/cubic foot into output polystyrene having a bulk density of 27 pounds/cubic foot or greater and running at a rate of 30 feet per minute or greater yields a ρ value of about 810 or greater.

In the example which processes 0.75 pounds/cubic foot into 27+ pounds/cubic foot at a rate of about 204 pounds per hour (S=30 feet per minute), the enhanced bulk density throughput index ρ is about 1080.

In yet another example which processes 0.50 pounds/cubic foot into 27+ pounds/cubic foot and running at a rate of 30 feet per minute the enhanced bulk density throughput index ρ is about 1620.

As compared to the example which began with polystyrene having a bulk density of about 1.5 pounds/cubic foot, the last aforementioned example has polystyrene of only about half of the mass of polystyrene with which to work, and yet produces resultant polystyrene having a bulk density in the same range (27 pounds/cubic foot to 30 pounds/cubic foot or more). Bulk density throughput of polystyrene through the apparatus commonly exceeds 200 pounds per hour, and thus far has reached as high as about 300 pounds per hour. Conveyor speeds of from about 30 feet per minute to and including 40 feet per minute are typical, but greater speeds can be obtained by increasing scale size as previously noted.

The high values of the enhanced bulk density throughput index ρ achieved by the present invention reflect the advantage of the apparatus of the present invention to run fast and process very low densities into high densities, without heat damage, at a rapid pounds-per-hour rate. By comparison, a prior art apparatus having a running speed limited to about 10-fpm and producing 30 PCF finished product using 1.5 PCF scrap foam input has an enhanced bulk density throughput index ρ of only about 200.

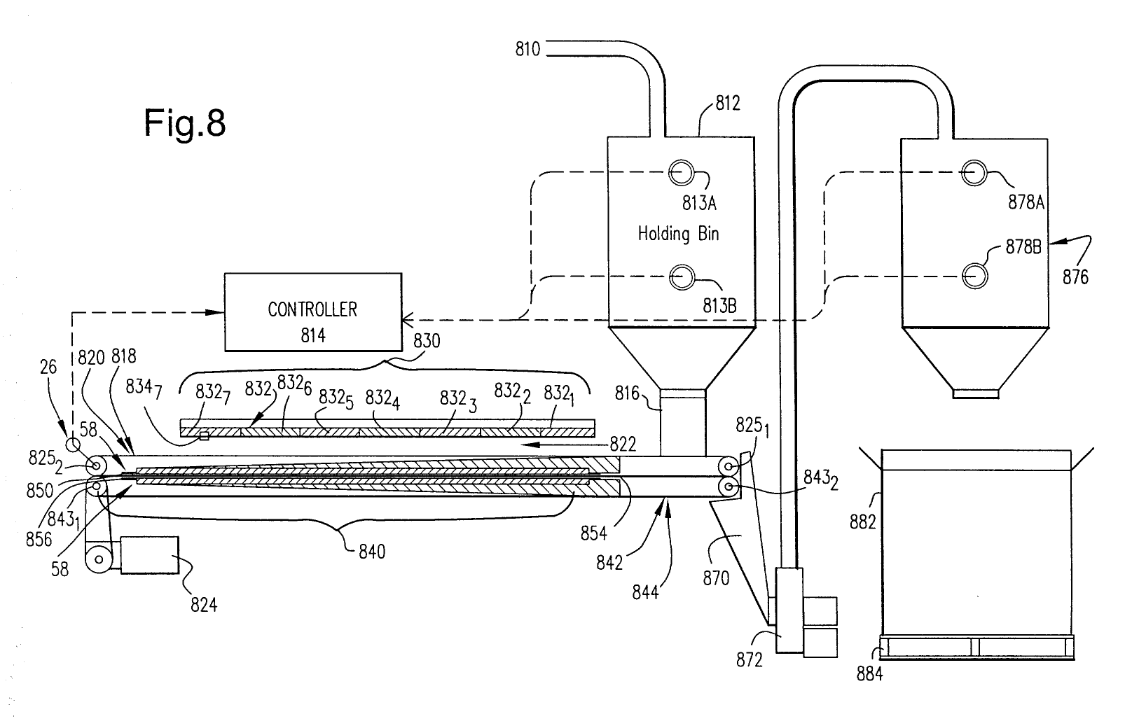

FIG. 8 shows a second example embodiment of structure and operation of the invention. Whereas in the embodiment of FIG. 1 the heating zone 30 is on the same horizontal plane as pressure zone 40, the embodiment of FIG. 8 basically differs in having its heating zone 830 oriented horizontally, but positioned above pressure zone 840. Elements of the embodiment of FIG. 8 which are comparable to those of the FIG. 1 embodiment bear reference numerals which are analogous in the least two significant digits, but have a “8” in the most significant digit. In view of the detailed discussion of the FIG. 1 embodiment as above provided, discussion of many of the comparable elements is not necessary for the FIG. 8 embodiment.

The heating zone 830 of the FIG. 8 embodiment can employ essentially the same heating structure as described in conjunction with the first embodiment (see, e.g., FIG. 8).

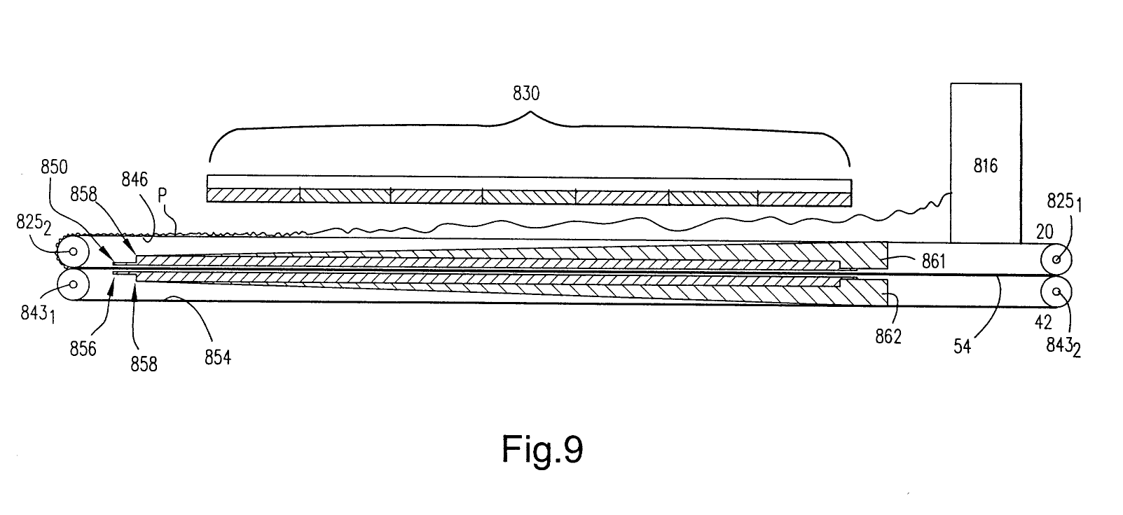

FIG. 9 shows a belt portion of the second embodiment in more detail. As can be seen in FIG. 9, near the exit of the polystyrene foam grind (“the material”) from the infrared emitter area (e.g., heating zone 830), preferably the polystyrene begins to coalesce; e.g., the discrete particles convert to a semi-molten state and join to form large globules, nearly forming a continuous mass. The semi-molten state polystyrene globules sticks to the outer surface 818 of first conveyor belt 820, so that the semi-molten state polystyrene globules remain on the outer surface 818 of first conveyor belt 820 as belt 820 rounds its downstream drive roller 825₂ and begins to travel in a reverse direction (i.e., a direction which is reverse to the direction indicated by arrow 822 (see FIG. 8)).

In the FIG. 8 embodiment, the flakes 69 release from between belts 820, 842 as belts 842 bend over the radius of its exit rollers 843₂, so that the flakes 69 fall into a collection system. The collection system can simply take the form of a holding bin collection box 882 such as the Gaylord® box described with reference to the first embodiment. Alternatively, the collection system can take the form of a suction chute 870 of transport blower 872. The flakes 69 can be broken into smaller parts (e.g. granules) by blower 872, and then air conveyed through duct 874 into a holding bin 876. Level detectors, such as detectors 878A, 878B shown in FIG. 8, open and close a slide gate 880 at the bottom of the bin 876 to automatically fill collection box 882 until the box 882 and its contents attain a suitable weight. Other collection mechanisms are also possible, especially mechanism which eliminate employment of a transport blower since usage of a transport blower 872 may create dust, which may be a source of problems for the polystyrene.

In pressure zone 840, aluminum heat sink 850, 856 contact the back (e.g., inner surfaces) of both belts 820, 842, respectively. In particular, aluminum heat sink 850 contacts the inner surface 846 of the first belt 820 along the lower path of travel of first belt 820, while aluminum heat sink 856 contacts the inner surface 854 of second conveyor belt 842 along the upper path of travel of second belt 842.

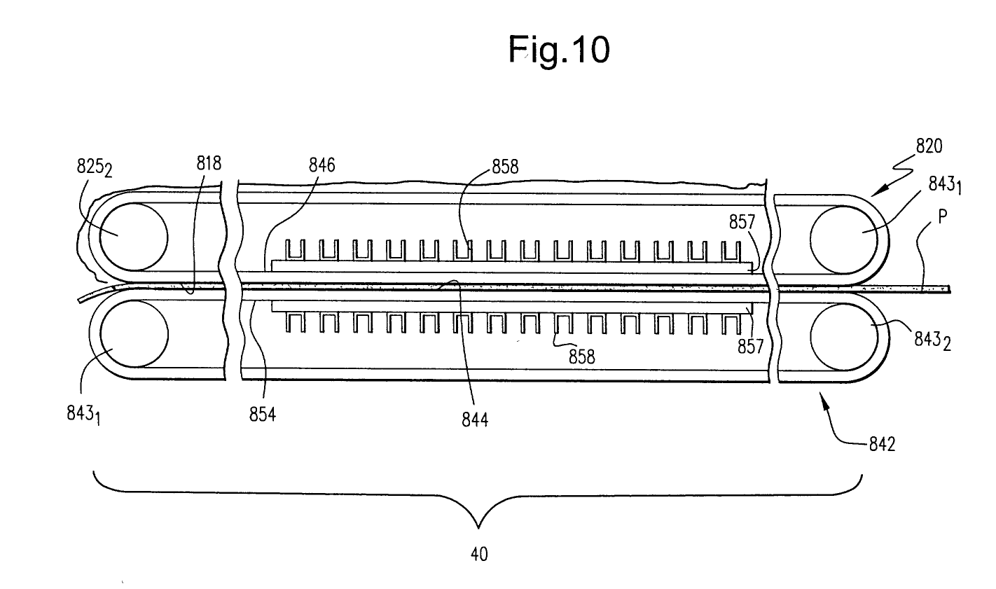

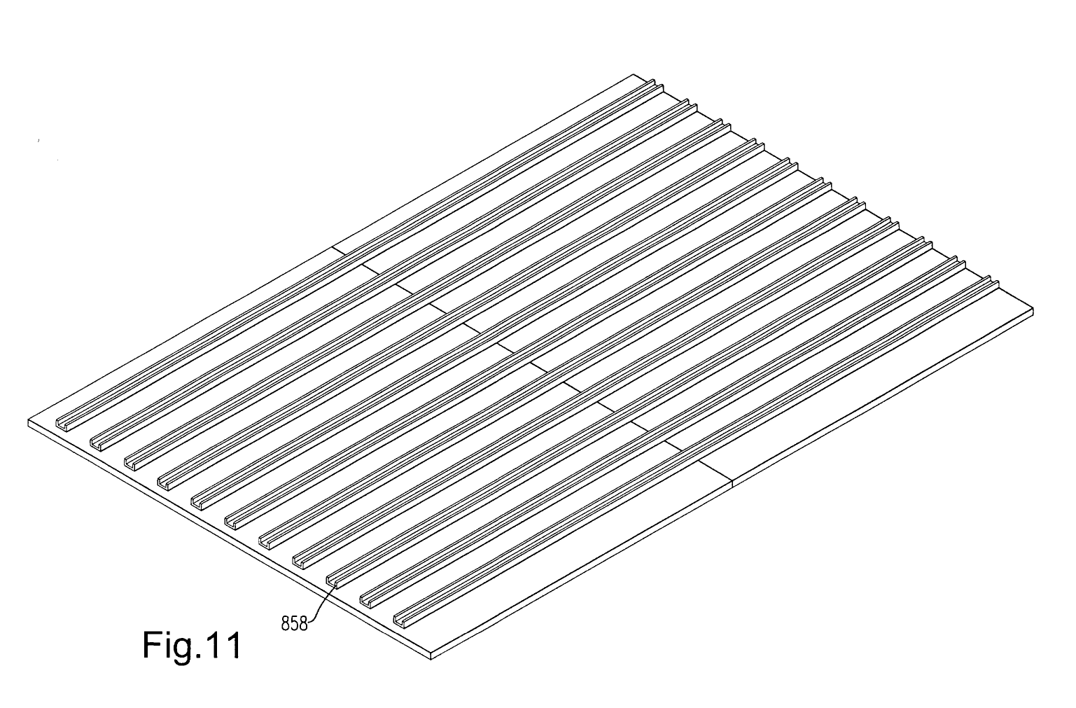

The aluminum heat sinks 850, 856 can take the form of rollers as in the FIG. 1 embodiment. Alternately, the aluminum heat sinks 850, 856 can take the form the representative example heat sink plate 857 shown in FIG. 10. FIG. 10 and FIG. 11 particularly show that the sink plate 857 is provided with aluminum cooling fins 858. In the example of FIG. 10 and FIG. 11, the cooling fins have an essentially U-shaped cross sectional shape, and facilitate heat dissipation.

To facilitate cooling of the polystyrene in pressure zone 840, the aluminum heat sinks 850, 856 are at least partially enclosed or encased in respective cooling manifolds 861, 862 (see FIG. 9). The cooling manifolds 861, 862 are connected to an unillustrated source of cooling air. The cooling manifolds 861, 862 preferably taper vertically in height (from right to left in the figures), having a lowest height proximate the drive rollers 825₂, 843₁. Cooling air enters the cooling manifolds 861, 862 at an end of maximum height, and is discharged from the cooling manifolds 861, 862 at an end of minimum height.

The foregoing example embodiments are but illustrative, non-limiting illustrations. For example, the implementations of the pressure mechanism previously described are not exhaustive ways of carrying out the sustained pressure application to the heated and softened polystyrene. For example, rather than using a second endless conveyor belt as part of the pressure mechanism, an essentially flat platen or other pressure applicator may be moved (e.g., pivoted or lowered) into contacting relationship for a predetermined time period with heated polystyrene travelling or indexed thereby. In such example, the heated polystyrene may be deposited upon a conveyor or other transport which indexes or steps the polystyrene through various stations including the heating zone and the pressure zone. Other implementations are also encompassed and embraced herein.

In one example implementation of the first embodiment of the present invention, the linear length of the heating panel section (e.g., heating zone 30) along the direction of granule transport 22 is about 92 inches. An open gap G (see FIG. 1) upstream from the top moving belt 42 is about 12 inches in length. This gap G allows some time for the heat of the polystyrene to stabilize throughout its now semi-molten masses. The linear length of the belt 42 (e.g., pressure zone) of this example embodiment is about 107 inches. The width of the structure of this preferred embodiment is about 24-inches.

In the above example implementation, the temperature of the heating elements are controlled such that the temperature of the polystyrene foam grind is at about 220° F. to about 230° F. as it coalesces and enters under pressure zone. The heating zone temperature is set (e.g., by the controller) to provide a coalescing grind entering the crushing zone (e.g., the pressure zone). In the illustrated embodiment the operator establishes, for any given batch of foam grind, a temperature for the heating zone that will cause the polystyrene to coalesce prior to entering the crushing zone.

The time that the polystyrene spends in the crushing zone to transform it to a fairly clear cooled solid will vary depending upon the speed of the transfer conveyor belt (20 or 820), the heat of the panels, and the specific softening point of the batch of polystyrene. Preferably the polystyrene material is held under a constant, uninterrupted pressure during a majority of the time that the polystyrene material is in the cooling stage (e.g., in the pressure zone).

The disclosed techniques and apparatus are thus in stark contrast to prior art methods which essentially universally heat the polystyrene foam to a very high temperature. Advantageously, the disclosed techniques and apparatus crush hot polystyrene (e.g., with an upper moving belt) and hold the pressure on the polystyrene until the gases are gone, and preferably until the plastic is cooled below the softening point of polystyrene. The disclosed techniques and apparatus thus capitalize upon a discovery that the best way for polystyrene to reach its maximum density is to crush a layer of coalescing foam particulate with moderate pressure until after it has reached its coalescing temperature, and then to hold the pressure on it until the gases escape (and preferably until the material cools). This method allows the plastic to be subjected to the least possible amount of total heat. Essentially all entrained gases are removed without applying a destructive amount of heat history to the recovered plastic material.

The crushing process does not require high levels of force. In much the same way a cook rolls out pie-crust or cookie dough, the disclosed techniques and apparatus reduce the thickness of coalesced polystyrene. In so doing, the entrained gases escape.

The disclosed techniques and apparatus also advantageously quickly recycle any form of polystyrene foam scrap, including Fire Retardant (FR, or bromine) treated foam, that is generated during a manufacturing process of molded expanded polystyrene foam products and any such material collected by community recycling programs.

Further, the disclosed techniques and apparatus facilitate rapidly recycling of any type of polystyrene foam scrap, including those modified with fire retardant bromines, in a way where the plastic is subjected to the least possible amount of total heat, thus providing the highest quality recycled polystyrene possible.

Moreover, in one of its aspects the disclosed apparatus is precisely controlled to such an extent that it does not require labor, or an operator's attention, to run in a continuous mode without compromising safety or creating a fire hazard.

As a yet further benefit, the disclosed techniques and apparatus convert foamed polystyrene scrap into solid plastic granules with a density approaching that of virgin pellets, so it can be directly fed into an extrusion process without the need for additional equipment.

While the invention has been described in connection with what is presently considered to be the most practical and preferred embodiment, it is to be understood that the invention is not to be limited to the disclosed embodiment, but on the contrary, is intended to cover various modifications and equivalent arrangements included within the spirit and scope of the appended claims.

The embodiments of the invention in which an exclusive property or privilege is claimed are defined as follows:

What is claimed is:

1. An apparatus for treating polystyrene foam comprising:
a heater which heats the polystyrene foam above a softening temperature of the polystyrene foam;
a pressure mechanism which applies and maintains pressure to crush heated and softened polystyrene so that polystyrene granules exiting from the pressure mechanism have an average thickness in a range of about 0.010 inch to about 0.035 inch.

2. An apparatus for treating polystyrene foam comprising:
a heater which heats the polystyrene foam above a softening temperature of the polystyrene foam;
a pressure mechanism comprising at least one set of two mutually-opposed endless conveyors which apply sustained pressure to crush heated and softened polystyrene.

3. An apparatus for treating polystyrene foam comprising:
a heater which heats the polystyrene foam above a softening temperature of the polystyrene foam but below a molten temperature of the polystyrene;
a pressure mechanism which applies pressure to crush the heated and softened polystyrene in a manner to obtain an enhanced bulk density throughput index ρ in excess of 500, the enhanced bulk density throughput index ρ being defined by the expression ρ=ΔBD×S×(1 min/ft), wherein ΔBD is a ratio of the bulk density of output polystyrene to the bulk density of input polystyrene; and S is a measure of a running speed of the polystyrene.

4. The apparatus of claims 1, 2, or 3, wherein the pressure mechanism maintains the pressure on the polystyrene until the polystyrene cools below a softening temperature of the polystyrene.

5. The apparatus of claims 1, 2, or 3, wherein the pressure mechanism provides controlled cooling and pressure, the controlled cooling and pressure being sufficient so that polystyrene exiting the pressure mechanism with a density of about 28 pounds per cubic foot or greater is obtained from polystyrene foam having a density prior to heating as low as about 0.50 pounds per cubic foot.

6. The apparatus of claims 1, 2, or 3, wherein the polystyrene foam prior to being heated has an initial density, wherein the pressure mechanism maintains the pressure on the polystyrene until the polystyrene cools below the softening temperature and the polystyrene exiting the pressure mechanism has an exiting density of about 28 pounds per cubic foot, and wherein the initial density is in a range of from about 0.50 pounds per cubic foot to 3.0 pounds per cubic foot.

7. The apparatus of claims 2 or 3, wherein the polystyrene exiting from the pressure mechanism is in the form of polystyrene granules, and wherein the polystyrene granules exiting from the pressure mechanism have an average thickness in a range of about 0.010 inch to about 0.035 inch.

8. The apparatus of claims 1, 2, or 3, wherein the heater heats the polystyrene foam to a temperature below a melting temperature of the polystyrene.

9. The apparatus of claims 1, 2, or 3, wherein a first conveyor conveys the polystyrene through the pressure mechanism.

10. The apparatus of claim 9, wherein the conveyor travels at a speed of 30 feet per minute or greater.

11. The apparatus of claim 9, further comprising means for lubricating the conveyor.

12. The apparatus of claim 9, wherein a first surface of the first conveyor contacts the polystyrene foam, and wherein a portion of the first conveyor which comprises the pressure mechanism has a second surface which contacts a heat sink.

13. The apparatus of claim 12, wherein the first conveyor is a stainless steel conveyor and the heat sink comprises aluminum rollers.

14. The apparatus of claim 12, further comprising a cooling system for cooling the heat sink.

15. The apparatus of claim 14, wherein the cooling system draws a fluid over the heat sink.

16. The apparatus of claim 9, wherein the pressure mechanism comprises a second conveyor situated in opposing relationship to the first conveyor, and wherein a force is applied to the polystyrene conveyed between the first conveyor and the second conveyor.

17. The apparatus of claim 16, wherein a first surface of one of the first conveyor and the second conveyor contacts the polystyrene foam, and a second surface of one of the first conveyor and the second conveyor contacts a heat sink.

18. The apparatus of claim 17, wherein one of the first conveyor and the second conveyor is a stainless steel conveyor and the heat sink comprises aluminum rollers.

19. The apparatus of claim 17, further comprising a cooling system for cooling the heat sink.

20. The apparatus of claim 19, wherein the cooling system draws a fluid over the heat sink.

21. The apparatus of claim 16, wherein a first surface of the first conveyor and a first surface of the second conveyor contact the polystyrene foam, and a second surface of the first conveyor contacts a first heat sink and a second surface of the second conveyor contacts a second heat sink.

22. The apparatus of claim 21, wherein the first conveyor and the second conveyor are stainless steel conveyors and the first heat sink and the second heat sink comprise aluminum rollers.

23. The apparatus of claim 21, further comprising a cooling system for cooling the first heat sink and the second heat sink.

24. The apparatus of claim 23, wherein the cooling system draws a fluid over the heat sink.

25. The apparatus of claim 16, wherein the second conveyor comprises a stainless steel conveyor, the stainless steel conveyor being in the form of a continuous loop entrained around two end rollers and having a conveyor interior surface, further comprising a steering system to retain the stainless steel conveyor in alignment, the steering system comprising:
a detector for detecting misalignment of the stainless steel conveyor;
a steering roller which, upon detection of misalignment by the detector, contacts a conveyor exterior surface of the stainless steel conveyor to urge the stainless steel conveyor into alignment.

26. The apparatus of claim 25, wherein the steering roller is pivotally mounted, and wherein the steering system further comprises an actuator which changes an axial inclination of the steering roller upon detection of misalignment by the detector so that a major axis of the steering roller tilts to cause the steering roller to contact the conveyor exterior surface of the stainless steel conveyor and thereby urge the stainless steel conveyor into alignment.

27. The apparatus of claim 9, wherein the first conveyor comprises a stainless steel conveyor, the stainless steel conveyor being in the form of a continuous loop entrained around two end rollers and having a conveyor interior surface, further comprising a steering system to retain the stainless steel conveyor in alignment, the steering system comprising:
a detector for detecting misalignment of the stainless steel conveyor;
a steering roller which, upon detection of misalignment by the detector, contacts a conveyor exterior surface of the stainless steel conveyor to urge the stainless steel conveyor into alignment.

28. The apparatus of claim 27, wherein the steering roller is pivotally mounted, and wherein the steering system further comprises an actuator which changes an axial inclination of the steering roller upon detection of misalignment by the detector so that a major axis of the steering roller tilts to cause the steering roller to contact the conveyor exterior surface of the stainless steel conveyor and thereby urge the stainless steel conveyor into alignment.

29. The apparatus of claim 16, wherein the polystyrene travels in a first direction on the first conveyor through a heating zone, wherein upon leaving the heating zone the polystyrene travels in a second direction opposite to the first direction through a pressure zone, the pressure zone comprising the second belt.

30. The apparatus of claims 1, 2, or 3, wherein the softening temperature of the polystyrene is preferably in a range between 170 degrees F. and 200 degrees F.

31. The apparatus of claims 1, 2, or 3, wherein the heater comprises plural heat emitter panels.

32. The apparatus of claim 31, wherein at least one of the plural heat emitter panels is selectively moveable into a proximate or non-proximate position relative to the polystyrene foam.

33. The apparatus of claims 1, 2, or 3, wherein the heater is heated by a variable voltage supply to an infrared wavelength suitable for the polystyrene foam.

34. The apparatus of claims 1, 2, or 3, wherein the apparatus converts polystyrene foam scrap back into solid polystyrene plastic, and wherein a time period during which the pressure mechanism maintains the pressure on the polystyrene is sufficient to vent essentially all entrained gases in the polystyrene foam without noticeable polymer degradation.

35. The apparatus of claim 34, wherein the polystyrene foam is brominated.

36. The apparatus of claims 1, 2, or 3, wherein the apparatus converts polystyrene foam scrap back into solid polystyrene plastic, and
and wherein a time period during which the pressure mechanism maintains the pressure on the polystyrene is sufficient to vent essentially all residual gases from the polystyrene without breaking high molecular weight polymers into lower molecular weight polymers.

37. The apparatus of claim 36, wherein the polystyrene foam is brominated.

38. The apparatus of claims 1 or 2, wherein the heater and the pressure mechanism facilitate treating the polystyrene to obtain an enhanced bulk density throughput index ρ in excess of 500, the enhanced bulk density throughput index ρ being defined by the expression ρ=ΔBD×S×(1 min/ft), wherein ΔBD is a ratio of the bulk density of output polystyrene to the bulk density of input polystyrene; and S is a measure of a running speed of the polystyrene.

39. The apparatus of claims 3 or 38, wherein the heater and the pressure mechanism facilitate treating the polystyrene to obtain an enhanced bulk density throughput index ρ in excess of 600.

40. A method for treating polystyrene foam comprising:
heating the polystyrene foam above a softening temperature of the polystyrene foam;
applying pressure to the heated polystyrene to crush heated and softened polystyrene and maintaining the pressure on the polystyrene so that polystyrene granules exiting from the pressure mechanism have an average thickness in a range of about 0.010 inch to about 0.035 inch.

41. A method for treating polystyrene foam comprising:
heating the polystyrene foam above a softening temperature of the polystyrene foam;
using a pressure mechanism comprising at least one set of two mutually-opposed endless conveyors to apply sustained pressure to crush heated and softened polystyrene.

42. A method for treating polystyrene foam comprising:
heating the polystyrene foam above a softening temperature of the polystyrene foam but below a molten temperature of the polystyrene;
applying pressure to the heated polystyrene to crush heated and softened polystyrene and maintaining the pressure on the polystyrene in a manner to obtain an enhanced bulk density throughput index ρ in excess of 500, the enhanced bulk density throughput index ρ being defined by the expression ρ=ΔBD×S×(1 min/ft), wherein ΔBD is a ratio of the bulk density of output polystyrene to the bulk density of input polystyrene; and S is a measure of a running speed of the polystyrene.

43. The method of claims 40, 41, or 42 further comprising maintaining the pressure on the polystyrene until the polystyrene cools below a softening temperature of the polystyrene.

44. The method of claims 40, 41, or 42 further comprising maintaining the pressure on the polystyrene so that after application of the pressure the polystyrene having a density of about 28 pounds per cubic foot or greater is obtained from polystyrene foam having a density prior to heating as low as about 0.50 pounds per cubic foot.

45. The method of claims 40, 41, or 42 wherein the polystyrene foam prior to being heated has an initial density, wherein the pressure is maintained on the polystyrene until the polystyrene cools below the softening temperature and after application of the pressure the polystyrene has an exiting density of about 28 pounds per cubic foot, and wherein the initial density is in a range of from about 0.50 pounds per cubic foot to 3.0 pounds per cubic foot.

46. The method of claims 41 or 42, wherein after application of the pressure the polystyrene is in the form of polystyrene granules, and wherein the polystyrene granules have an average thickness in a range of about 0.010 inch to about 0.035 inch.

47. The method of claims 40, 41, or 42 wherein the step of heating the polystyrene foam comprises heating the polystyrene foam to a temperature below a melting temperature of the polystyrene.

48. The method of claims 40, 41, or 42 comprising using a first conveyor for conveying the polystyrene through the pressure mechanism.

49. The method of claim 48, further comprising moving the first conveyor at a speed of 30 feet per minute or greater.

50. The method of claim 48, further comprising lubricating the first conveyor.

51. The method of claim 48, further comprising using a first surface of the first conveyor to contacts the polystyrene foam, and in a portion of the first conveyor which comprises the pressure mechanism, using a second surface of the first conveyor to contact a heat sink.

52. The method of claim 51, further comprising cooling the heat sink.

53. The method of claim 52, further comprising cooling the heat sink by drawing a fluid over the heat sink.

54. The method of claim 48, further comprising using a second conveyor situated in opposing relationship to the first conveyor for applying a force to the polystyrene conveyed between the first conveyor and the second conveyor.

55. The method of claim 54, further comprising using a first surface of one of the first conveyor and the second conveyor to contact the polystyrene foam, and using a second surface of one of the first conveyor and the second conveyor to contact a heat sink

56. The method of claim 55, further comprising cooling the heat sink.

57. The apparatus of claim 56, further comprising cooling the heat sink by drawing a fluid over the heat sink.

58. The method of claim 54, further comprising using a first surface of the first conveyor and a first surface of the second conveyor to contact the polystyrene foam, using a second surface of the first conveyor to contact a first heat sink, and using a second surface of the second conveyor to contact a second heat sink.

59. The method of claim 58, further comprising cooling the first heat sink and the second heat sink.

60. The method of claim 59, further comprising cooling the first heat sink and the second heat sink by drawing a fluid over the first heat sink and the second heat sink.

61. The method of claim 54, wherein the second conveyor comprises a stainless steel conveyor, the stainless steel conveyor being in the form of a continuous loop entrained around two end rollers and having a conveyor interior surface, further comprising:
detecting misalignment of the stainless steel conveyor; and, upon detection of misalignment by the detector,
contacting a conveyor exterior surface of the stainless steel conveyor to urge the stainless steel conveyor into alignment.

62. The method of claim 61, further comprising changing an axial inclination of a steering roller upon detecting the misalignment so that a major axis of the steering roller tilts to cause the steering roller to contact the conveyor exterior surface of the stainless steel conveyor and thereby urge the stainless steel conveyor into alignment.

63. The method of claim 48, wherein the first conveyor comprises a stainless steel conveyor, the stainless steel conveyor being in the form of a continuous loop entrained around two end rollers and having a conveyor interior surface, further comprising:
detecting misalignment of the stainless steel conveyor; and, upon detection of misalignment by the detector,
contacting a conveyor exterior surface of the stainless steel conveyor to urge the stainless steel conveyor into alignment.

64. The method of claim 63, further comprising changing an axial inclination of a steering roller upon detecting the misalignment so that a major axis of the steering roller tilts to cause the steering roller to contact the conveyor exterior surface of the stainless steel conveyor and thereby urge the stainless steel conveyor into alignment.

65. The method of claim 48, wherein the polystyrene travels in a first direction on the first conveyor through a heating zone, wherein upon leaving the heating zone the polystyrene travels in a second direction opposite to the first direction through a pressure zone, the pressure zone comprising the second belt.

66. The method of claims 40, 41, or 42 further comprising heating the polystyrene so that the polystyrene coalesces prior to applying the pressure.

67. The method of claim 66, further comprising heating the polystyrene foam to a temperature in a range from about 220 degrees F. to about 230 degrees F.

68. The method of claims 40, 41, or 42 wherein the softening temperature of the polystyrene is preferably in a range between 170 degrees F. and 200 degrees F.

69. The method of claims 40, 41, or 42 further comprising using a variable voltage supply to heat the polystyrene to an infrared wavelength suitable for the polystyrene foam.

70. The method of claims 40, 41, or 42 wherein the method converts polystyrene foam scrap back into solid polystyrene plastic, and wherein a time period during which the pressure is maintained on the polystyrene is sufficient to vent essentially all entrained gases in the polystyrene foam without noticeable polymer degradation.

71. The method of claim 70, wherein the polystyrene foam is brominated.

72. The method of claims 40, 41, or 42 wherein the method converts polystyrene foam scrap back into solid polystyrene plastic, and
and wherein a time period during which the pressure mechanism maintains the pressure on the polystyrene is sufficient to vent essentially all residual gases from the polystyrene without breaking high molecular weight polymers into lower molecular weight polymers.

73. The method of claim 72, wherein the polystyrene foam is brominated.

74. The method of claims 40 or 41, wherein heating and applying the pressure facilitate treating the polystyrene to obtain an enhanced bulk density throughput index ρ in excess of 500, the enhanced bulk density throughput index ρ being defined by the expression ρ=ΔBD×S×(1 min/ft), wherein ΔBD is a ratio of the bulk density of output polystyrene to the bulk density of input polystyrene; and S is a measure of a running speed of the polystyrene.

75. The method of claims 42 or 74, wherein the heater and the pressure mechanism facilitate treating the polystyrene to obtain an enhanced bulk density throughput index ρ in excess of 600.

76. A product produced by the method of claim 40.

77. A product produced by the method of claim 41.

78. A product produced by the method of claim 42.

79. A product produced by the method of claim 43.

80. A product produced by the method of claim 44.

81. A product produced by the method of claim 70.

82. A product produced by the method of claim 72.

83. An apparatus for converting polystyrene foam into a higher density plastic comprising one or more conveyor belts made of stainless steel.

84. An apparatus for converting polystyrene foam having a majority of cells into a higher density plastic having virtually no cells comprising one or more conveyor belts made of stainless steel.
